(19) United States
(12) Patent Application Publication
(10) Pub. No.: US 2014/0103183 A1
(43) Pub. Date: Apr. 17, 2014

(54) AUTO LOCKS STAY ROD FOR CABIN OF A VEHICLE

(71) Applicants: Sachin Eknathrao Lokhande, Mumbai (IN); Nilesh Siddeshwar Choudhari, Mumbai (IN)

(72) Inventors: Sachin Eknathrao Lokhande, Mumbai (IN); Nilesh Siddeshwar Choudhari, Mumbai (IN)

(21) Appl. No.: 13/983,486

(22) PCT Filed: Feb. 3, 2012
(86) PCT No.: PCT/IN2012/000084

§ 371 Date: Jan. 2, 2014

(30) Foreign Application Priority Data
Feb. 4, 2011 (IN) 321/MUM/2011

(51) Int. Cl. B62D 33/07

(52) U.S. Cl. CPC B62D 33/07
USPC 248/352

(57) ABSTRACT

The invention relates to an auto lock stay rod for cabin of a vehicle for mounting over the chassis. The said stay rod comprises two links, one top (2) link connected to the cabin tilt able by cylinder through one pivotable joint (5) other bottom link (3) connected to chassis through another pivotable joint. (4) The said Top link (2) and bottom link (3) connected to each other by a pin joint (10). A Locking lever (1), having a hook one side and a lug stopper opposite side, mounted over top link in the hollow portion provided therein with pin bearing (15). A spring (8) bias provided to said lever so that the lever normally at an angle to said top link with said hook resting on top link surface due to spring bias. A clip means (7) provided over the said top link for release ably holding the lever end therein so that the said hook faces upper side and stopper lug at lower side protruding out of said top link A square plate (12) with slot in centre welded to the said bottom link sloping end at pivot joint side. A striker (6) welded to the said bottom link facing the said stopper lug when lever held in the said clip.

### FIELD OF INVENTION

The present invention is related to cab tilt stay rod of a vehicle. More particularly the present invention is related to cabin tilt stay rod mechanism with three non-collinear points so as to ensure unidirectional folding and facilitates the locking and auto-release of the lever by using a steel spring and a striker arrangement so as to simplify human interface with the working of stay rod.

### BACKGROUND OF THE PRESENT INVENTION

In conventional design of stay rod when lowering the cabin, operator has to unlock stay rod lever and push the centre pivot point from opposite direction so as to ensure folding of stay rod in desired direction also the tilt pump (external mean used to cab tilting) should be operated at the same time making the sequence of operation complicated and uncertain. Also in case of existing design of stay rod, centre hinge point is in-line with two mounting points which makes stay rod folding direction uncertain i.e. inward OR outward.

In present invention, spring clip holds the stay rod lever so that operator can operate it once and then operating the tilt pump to get the cabin down. This simplifies the operation of stay rod and reduces human intervention, effort, time and makes procedure very safe. In conventional design of stay rod, at each step of cab lowering, the operator has to judge the position of the CG (centre of gravity) so as to operate the stay rod. This requires skill, time and also makes the process uncertain. Moreover while lowering the cab it demands one more operator to operate the stay rod.

In present invention of the cab-tilt stay rod, centre hinge point is non-collinear with two mounting points thus ensuring folding of the stay rod in desired direction only.

In proposed invention the need for an extra operator is completely eliminated by providing spring clip locking arrangement for lever. This steel spring holds the lever till the cab is dropped and releases automatically at the end of the drop making it ready for the succeeding event of tilting the cab. This also simplifies the process, makes it more reliable and time effective. The centrally located steel spring and the striker maintain the uniform distribution of load and make the mechanism more compact and balanced.

### DEFICIENCIES IN CONVENTIONAL DESIGN

The conventional design does not have an arrangement for locking and releasing the lever of the stay rod.
There is a possibility that the operator may not give a push/operate the stay rod before lowering the cab; this may damage the stay rod causing it to buckle against the axial load.
It requires either a skilled operator or one more person to operate the stay rod while lowering the cab. So a certain level of skill is required for safe and proper tilting and lowering of the cab.
While tilting the cabin, stay rod link gets unfolded about center axis through pin joint and when the cabin is tilted its position is retained by the stay rod.
While lowering the cabin, the folding of the stay rod requires a human intervention. The operator has to unlock the locking lever and also need to provide a gentle push to rod at the center pin joint. In conventional design the center pin joint is along the axis passing through the top and bottom mounting points, so there is uncertainty in the bending direction of stay rod. Thus the pushing of stay rod is necessary to ensure bending of stay rod in desired direction.
There is always a danger that if the operator does not give a push to the stay rod before operating cab tilt pump, then it may damage the stay rod causing it to buckle against the axial load exerted by tilting cylinder. Thus simultaneous operations of unlocking the lever, pushing the stay rod as well as pumping the tilt pump is required to be done.

### OBJECTIVES OF THE PRESENT INVENTION

The main object of this invention is to provide auto lock stay rod mechanism for tiltable cabins of a vehicle which scores in the following areas:
1. full proof design that ensures the folding of stay rod with minimum human intervention.
2. an Auto-release arrangement to unlock the locking lever by using the relative motion of the stay rod links.
3. an inventive arrangement which makes stay rod operation more user friendly.
4. reduces ambiguity of sequence of operations while lowering the cabin.

### STATEMENT OF INVENTION

Accordingly the invention provides An auto lock stay rod for cabin of a vehicle for mounting over the chassis comprises two links, one top link connected to the cabin tilt able by cylinder through one pivotable joint other bottom link connected to chassis through another pivotable joint; the said Top link and bottom link connected to each other by a pin joint; a Locking lever, having a hook one side and a lug stopper opposite side, mounted over top link in the hollow portion provided therein with pin bearing; a spring bias provided to said lever so that the lever normally at an angle to said top link with said hook resting on top link surface due to spring bias; a clip means provided over the said top link for releaseably holding the lever end therein so that the said hook faces upper side and stopper lug at lower side protruding out of said top link; a square plate with slot in centre welded to the said bottom link sloping end at pivot joint side; a striker welded to the said bottom link facing the said stopper lug when lever held in the said clip.

### DESCRIPTION OF THE FIGURES

The following detailed drawings will help to have a better understanding of the mechanism of the present invention.

FIG. 1 describes the position of the stay rod in folded condition under the dropped cabin.

FIG. 2 shows a magnified view of the stay rod which is in a closed position as shown in FIG. 1.

FIG. 3 shows a sectional view of the locking lever end held by the steel clamp.

FIG. 4 shows an isometric view of the stay rod.

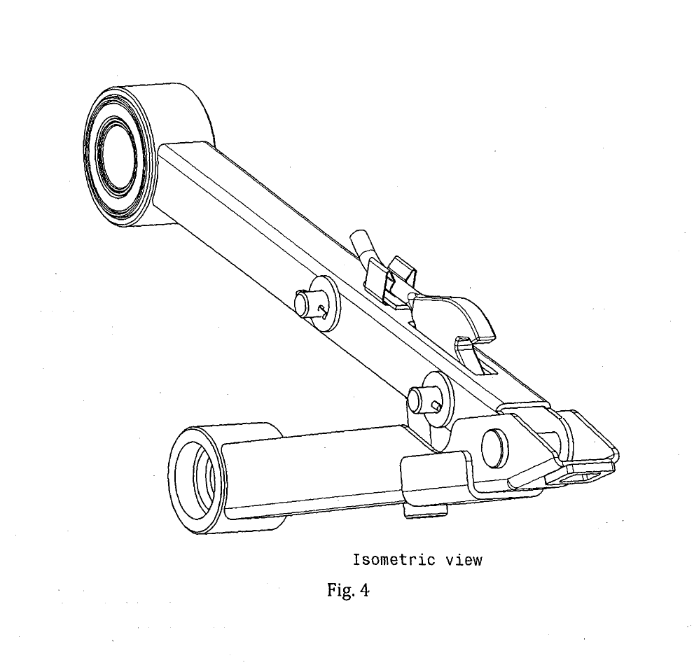

FIG. 5 shows a position of the stay rod in unfolded condition.

FIG. 6 shows magnified view of the stay rod when the cab is in the tilted position.

FIG. 7 shows exploded view of auto lock stay rod in accordance with the present invention.

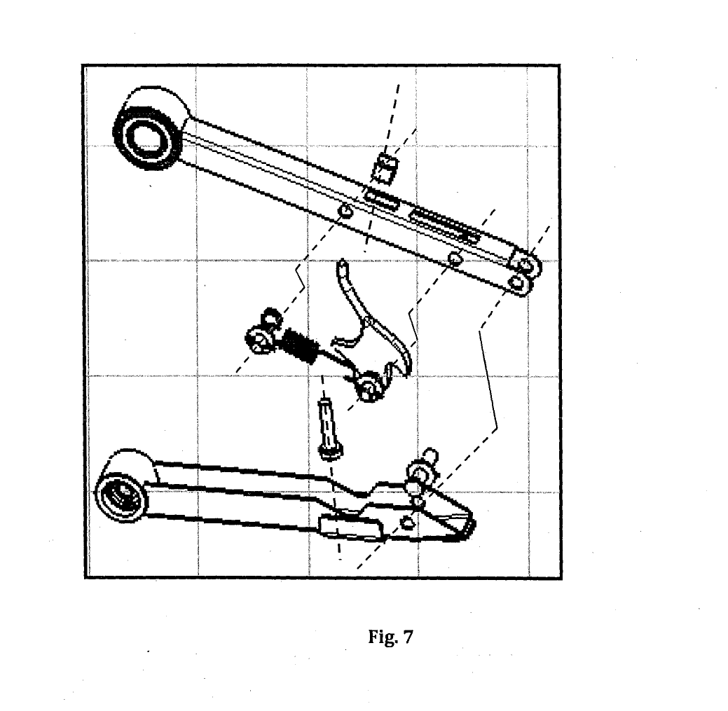

### DETAILED DESCRIPTION OF THE PRESENT INVENTION

The present invention relates to trucks having a semi-forwarded engine, the engine is accessed by tilting the cabin and retaining its tilted position with the help of a stay rod. In this class of vehicles, the cabin is pivoted about a transverse axis passing through the front cab mounts, to facilitate the servicing of engine.

Basic functions of cabin tilt stay rod are:
1. To hold the cabin in maximum tilt condition (i.e. prevent fall back and fro of cabin).
2. Isolate cabin from chassis when cabin is in riding position.
3. Should not hamper cabin ride.
4. Should not create noise/rattle in vehicle running condition.

In the proposed invention, the centre hinge point is non-collinear with two mounting points (top and bottom) thus ensuring folding of the stay rod in desired direction without any human intervention. This eliminates the extra operation of giving push. An arrangement has been provided in which the locking lever is retained in a spring clamp which is mounted on the top link of the stay rod. Before un-tilting operation i.e. before pumping the cabin down, the operator can unlock the stay rod lever against the spring clamp. This locked stay rod lever needs to be released so that it will facilitate auto locking in next tilt cycle. So an arrangement of striker is made for releasing stay rod lever lock automatically by using folding motion of stay rod links while lowering the cab. The design is more robust, simple and safer to operate and can be operated conveniently by just a single operator.

This preferred embodiment of the invention is the stay rod mechanism; which plays a vital role in the tilting and lowering of the cabin. The stay rod unfolds during the tilting of the cabin and maintains the tilted position of the cabin. It folds about a hinge point (the connecting point for the two arms of the stay rod) while lowering the cab. An arrangement of mechanism is made to retain the unlocked position of the lever (used to lock the stay rod) and its automatic release by using the relative motion of the folding arms. Thus, the fool proof folding of the stay rod and the auto release of locking lever makes the mechanism self reliant, safer and saves the time required for the tilting and lowering the cab.

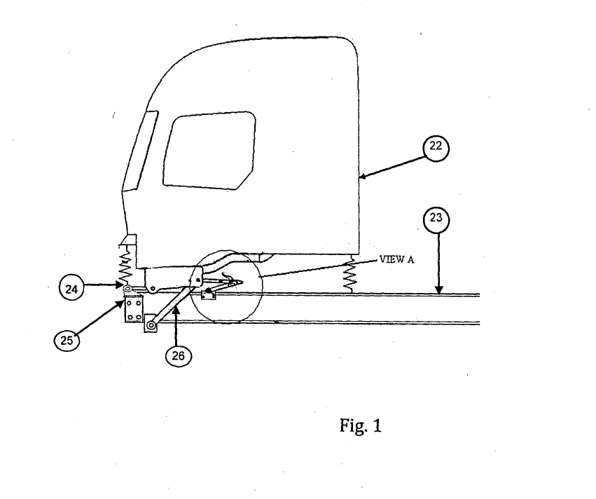

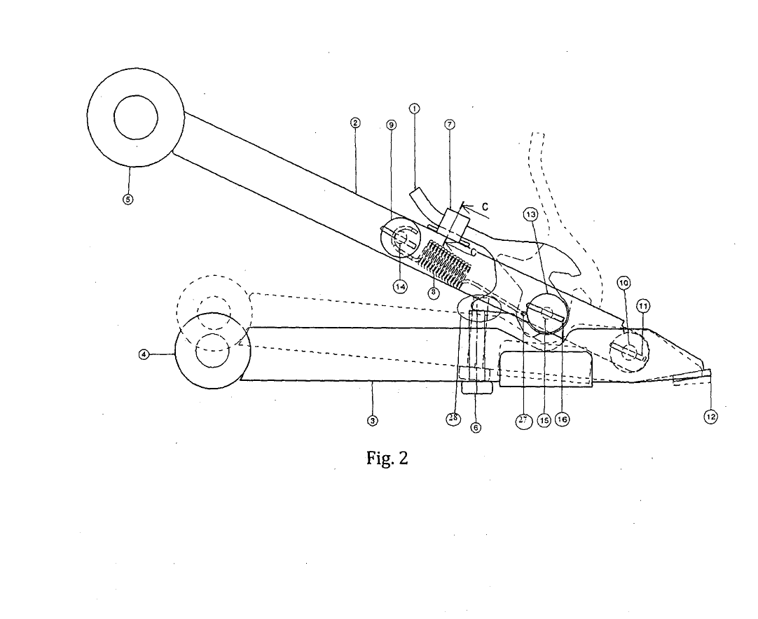

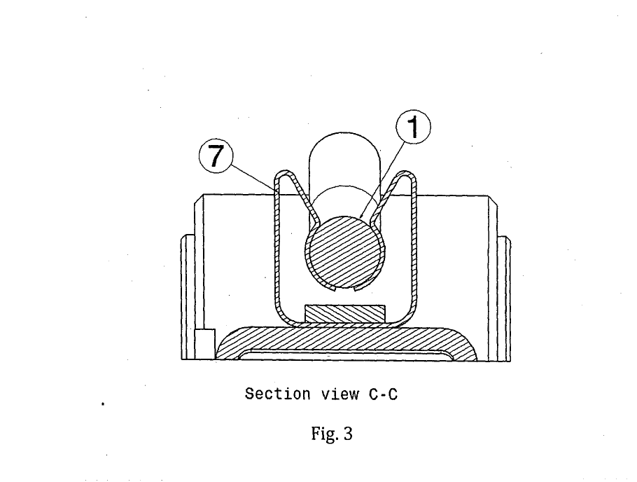

As shown in FIG. 1 the cabin 22 is mounted over the chassis 23 and the stay rod remains in a closed position with top end 5 connected to the cabin 22 and bottom end 4 to the chassis 23. The cabin 22 is pivoted about a transverse axis 24 passing through the bracket 25, which is fixed on chassis 23. This cabin 22 can be tilted by a tilting device like tilt cylinder 26 as shown in FIG. 1. The two links of the stay rod, i.e. top link 2 connected to the cabin 22 through pivotable joint 5 and to chassis 23 through another pivotable joint 4. Top link 2 and bottom link 3 are connected to each other by a pin joint 10. Locking lever 1 is mounted over top link 2. As shown in FIG. 2 the top portion of the lever 1 has a circular cross section as shown in the FIG. 3 (section C-C). This lever 1 rotates about the pin 15 which in turn is locked with a washer 13 and a split-pin 16. One end of an extension spring 8 is connected to the lever 1 at joint 27 and other end to top link 2 by pin joint 14. This extension spring 8 maintains the position of the lever. Pin 14 is locked by a split-pin 9. The front portion of the bottom link 3 bears a slope of an angle as shown in FIG. 2. The striker 6 is welded with the bottom link 3. A square plate 12 with a slot (to accommodate the locking lever 1) is also welded to the front bent portion of the bottom link 3. The steel spring clamp 7 is welded to the top link 2 axially at an appropriate position so that it can lock end portion of lever 1.

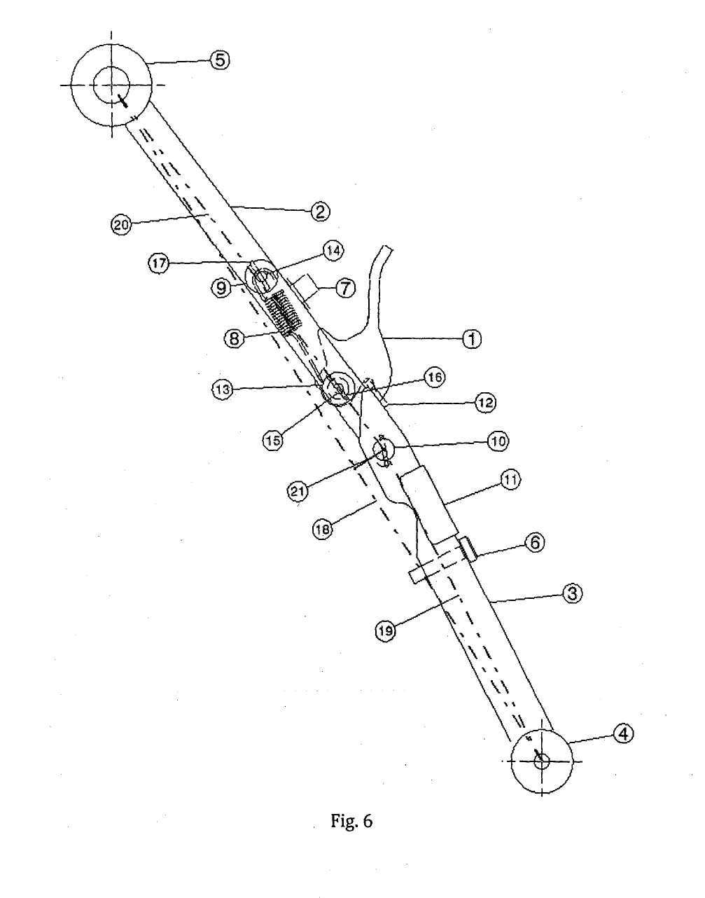

As shown in FIG. 6. An axis 18 is passing through the two end mounting points i.e. from the chassis end 4 to the cabin end 5. The axis 19 passes through the mounting point 4 at the chassis end to the pin 10 about which the two links 2 & 3 gets folded. Also an axis 20 passes through the pin 10 and the mounting point at the cabin end 5. The distance 21, is the off-set distance of the pin 10 from the axis 18 connecting the two end mounting points.

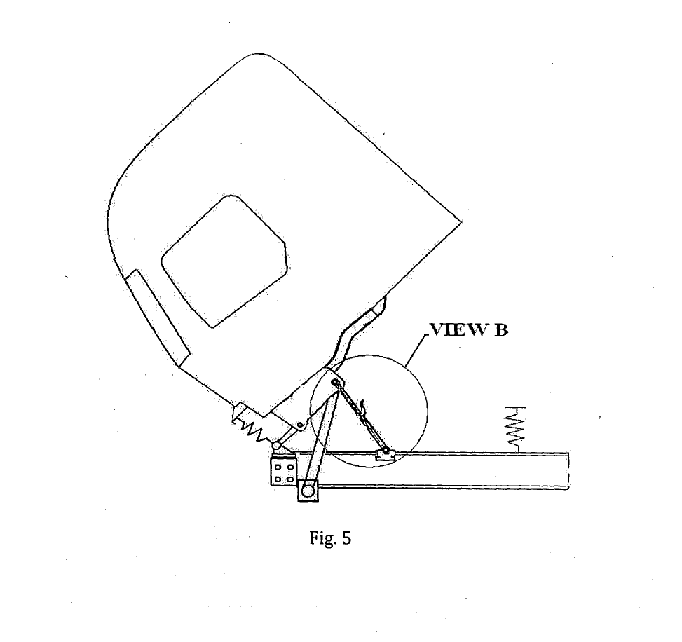

When the vehicle is in the running condition (or when the cabin rests over the chassis), the stay rod links remains in a closed position as shown in the FIG. 1. When the cabin 22 is tilted the stay rod unfolds about the pin joint 10 and attains the final position as shown in the FIG. 5. During tilting operation (i.e. while unfolding of the stay rod), the square plate welded over the bottom link 3 strikes gradually against the lever (held under tension with an extension spring 8) causing it to rotate about pin 16. This rotating lever 1 locks the two links 2 & 3 as soon as it enters the slot in the square plate 12 and the stay rod is ready to hold the cabin in its tilted position. FIG. 5 shows the position of the stay rod in which the cabin 22 remains in a tilted position.

The pin joint 10 always remains at a distance 21 from the axis passing through the two end mounting points 4 & 5 as shown in FIG. 6. This off-set distance of the pin 10 compels the rod to fold in the desired outward direction during lowering of the cabin 22. This feature eliminates the human intervention and also makes the mechanism simple and safe. Before lowering the cabin the locking lever 1 is pressed manually against the steel clamp 7, in which it gets locked under tension. While lowering the cabin 22, the stay rod folds about the pin joint 10. Just before the end of the drop of cabin 22 the two links 2 & 3 converges about the pin joint 10, the striker 6 hits the lever 1 from bottom in region 28 as shown in FIG. 2 and releases it from the spring clamp 7. Thus this auto release mechanism makes the locking lever 1 ready again for the subsequent operation of tilting.

Thus, in the present invention an arrangement for locking the lever with the spring clip and auto-release of the lever with the striker has been provided, which uses the relative motion of stay rod links while lowering the cab. The hinge point being non-collinear with the mounting points doesn't allow the stay rod to buckle and in case of excessive loading bends in the desired direction. It is more robust, simple and safer to operate by just a single operator conveniently.

The auto lock stay rod as disclosed in the present invention is used for,
(i) tiltable truck cabin with four point suspension.
(ii) tiltable truck cabin with two point rubber mount suspension.
(iii) the front flap of a vehicle like truck, bus etc.
(iv) luggage door flap of a sleeper cab in the vehicle.
(v) trunk and engine bonnet of a vehicle.
(vi) all the storage lids.
(vii) drop-side load bodies.

1. An auto lock stay rod for cabin of a vehicle for mounting over the chassis, the auto lock stay rod comprising:
a top link connected to the cabin and tiltable by a cylinder through one pivotable joint, and a bottom link connected to chassis through another pivotable joint; the top link and bottom link connected to each other by a pin joint;
a locking lever, having a hook one side and a lug stopper on an opposite side, mounted over the top link in a hollow portion provided therein with a pin bearing;
a spring bias provided to said lever so that the lever is normally at an angle to said top link with said hook resting on a top link surface due to spring bias;
a clip means provided over the top link for releaseably holding the lever end therein so that the hook faces the upper side and the stopper lug at the lower side is protruding out of said top link;
a square plate with slot in center welded to the bottom link sloping end at a pivot joint side; and
a striker welded to the bottom link facing the stopper lug when the lever is held in the clip.

2. The auto lock stay rod as claimed in claim 1, wherein the spring bias comprises one end of spring fixed to the lever near to the pin bearing and other end is fixed to the top link by a fixed pin means.

3. The auto lock stay rod as claimed in claim 1, wherein the lever end portion is circular cross section, and pin bearing portion is flat with hook and stopper lug integrally formed therein.

4. The auto lock stay rod as claimed in claim 1, wherein the lever is fixed to the top link hollow potion therein by a pin with a washer, and wherein the pin is locked by split pin.

5. The auto lock stay rod as claimed in claim 1, wherein the clip means comprises a spring steel clamp having U-shape with ends bent inwards having semicircular shape.

6. The auto lock stay rod as claimed in claim 5, wherein the clip is welded to the top link at location towards said pivot joint end so that lever end gets locked when rotated towards the clip.

7. The auto lock stay rod as claimed in claim 1, wherein for positive folding of said top and bottom links the axis passing through ends connecting the said both pivot joints to cabin and chassis having offset distance provided from the pin joint.

8. The auto lock stay rod as claimed in claim 2, wherein the said lever end portion is circular cross section and pin bearing portion is flat with hook and stopper lug integrally formed therein.

9. The auto lock stay rod as claimed in claim 2, wherein the said lever fixed to the top link hollow potion therein by a pin with a washer, and wherein the pin is locked by a split pin.

10. The auto lock stay rod as claimed in claim 3, wherein the said lever fixed to the top link hollow potion therein by a pin with a washer, and wherein the pin is locked by a split pin.

11. The auto lock stay rod as claimed in claim 2, wherein the clip means comprises a spring steel clamp having U-shape with ends bent inwards having semicircular shape.

12. The auto lock stay rod as claimed in claim 3, wherein the clip means comprises a spring steel clamp having U-shape with ends bent inwards having semicircular shape.

13. The auto lock stay rod as claimed in claim 4, wherein the clip means comprises a spring steel clamp having U-shape with ends bent inwards having semicircular shape.

14. The auto lock stay rod as claimed in claim 2, wherein for positive folding of said top and bottom links, the axis passing through ends connecting the pivot joints to cabin and chassis have an offset distance provided from the pin joint.

15. The auto lock stay rod as claimed in claim 3, wherein for positive folding of said top and bottom links, the axis passing through ends connecting the pivot joints to cabin and chassis have an offset distance provided from the pin joint.

16. The auto lock stay rod as claimed in claim 4, wherein for positive folding of said top and bottom links, the axis passing through ends connecting the pivot joints to cabin and chassis have an offset distance provided from the pin joint.

17. The auto lock stay rod as claimed in claim 5, wherein for positive folding of said top and bottom links, the axis passing through ends connecting the pivot joints to cabin and chassis have an offset distance provided from the pin joint.

18. The auto lock stay rod as claimed in claim 6, wherein for positive folding of said top and bottom links, the axis passing through ends connecting the pivot joints to cabin and chassis have an offset distance provided from the pin joint.
